(19) United States
(12) Patent Application Publication
(10) Pub. No.: US 2026/0138631 A1
(43) Pub. Date: May 21, 2026

(54) SYSTEMS AND METHODS FOR DRIVER ASSISTANCE AND AUDIO SYSTEM INTEGRATION

(71) Applicant: Harman Becker Automotive Systems, Inc., Novi, MI (US)

(72) Inventor: Zhijun Chen, Kanagawa (JP)

(21) Appl. No.: 18/951,426

(22) Filed: Nov. 18, 2024

(51) Int. Cl. B60W 50/14; B60K 35/26; B60W 50/029

(52) U.S. Cl. CPC B60W 50/14; B60K 35/26; B60W 50/029; B60W 2050/143; B60W 2050/146

(57) ABSTRACT

Systems and methods are disclosed for an electronic control unit for a vehicle. In one example, an electronic control unit for a vehicle includes an audio network interface configured to receive an audio input signal, a vehicle network interface configured to receive one or more vehicle signals, a non-transitory memory storing instructions, and a processor communicably coupled to the audio network interface, the vehicle network interface, and the non-transitory memory. The processor, when executing the instructions, is configured to receive the audio input signal and the one or more vehicle signals, generate a notification in response to the one or more vehicle signals, mix the notification and the audio input signal to produce a mixed audio output signal, transmit the mixed audio output signal to an amplifier, and play the mixed audio output signal via a speaker, wherein the electronic control unit is functional safety compliant.

### FIELD

The present invention generally relates to the field of driver assistance systems and, more particularly, to methods and systems for integrating driver assistance systems with vehicle audio systems.

### BACKGROUND

Advanced driver-assistance systems (ADAS) are technologies that monitor vehicle operating conditions and assist with the operation of a vehicle. Through a human-machine interface, ADAS use automated technology, such as sensors and cameras, to detect driving obstacles, driver errors, and other situations, and respond accordingly. Some examples of ADAS include generating a notification, such as an alert sound, when a driver error is indicated or an obstacle is detected in the road.

ADAS components may be subject to functional safety (FUSA) requirements. In general, FUSA requirements are set to ensure reliable operation of systems under a variety of conditions. As a few examples, FUSA requirements may include design and system architecture features that incorporate redundancy, fault tolerance, and fail-safe mechanisms to handle potential failures, such as for hardware and software components. FUSA compliant systems may undergo monitoring and management of functional safety through the lifecycle of the system.

Achieving FUSA compliance may be challenging for complex systems, as each component in the system may be individually assessed, engineered to meet FUSA requirements, integrated, and monitored. As a result, vehicles may include systems that are FUSA compliant, such as an ADAS, and some that are not, such as an audio system.

### SUMMARY

Embodiments are disclosed for systems and methods for an electronic control unit of a vehicle. The systems and methods described herein integrate advanced driver-assistance system operations with a variety of vehicle audio systems.

In one aspect, an electronic control unit for a vehicle includes an audio network interface configured to receive an audio input signal, a vehicle network interface configured to receive one or more vehicle signals, a non-transitory memory storing instructions, and a processor communicably coupled to the audio network interface, the vehicle network interface, and the non-transitory memory. The processor, when executing the instructions, is configured to receive the audio input signal and the one or more vehicle signals. The processor is configured to generate a notification in response to the one or more vehicle signals and mix the notification and the audio input signal to produce a mixed audio output signal. The processor is configured to transmit the mixed audio output signal to an amplifier, and play the mixed audio output signal via a speaker, wherein the electronic control unit comprises a first functional safety level greater than or equal to a functional safety compliance threshold.

In another aspect, a method for an electronic control unit for a vehicle includes receiving, via one or both of a head unit and an amplifier, an audio input signal and receiving, via an ADAS, one or more vehicle signals. The method includes generating a notification in response to the one or more vehicle signals and mixing the notification and the audio input signal to produce a mixed audio output signal. The method includes transmitting the mixed audio output signal to the amplifier, and playing, via a speaker, the mixed audio output signal, wherein the electronic control unit comprises a first functional safety level greater than or equal to a functional safety compliance threshold.

In yet another aspect, a system for a vehicle comprises a head unit, an amplifier, a speaker, an ADAS, and an electronic control unit communicably coupled to the head unit, the amplifier, the speaker, and the ADAS. The electronic control unit includes an audio network interface configured to receive an audio input signal from one or both of the head unit and the amplifier, a vehicle network interface configured to receive one or more vehicle signals from the ADAS, a non-transitory memory storing instructions, and a processor communicably coupled to the audio network interface, the vehicle network interface, and the non-transitory memory. When executing the instructions, the processor is configured to receive the audio input signal and receive the one or more vehicle signals. The processor is configured to generate a notification in response to the one or more vehicle signals and mix the notification and the audio input signal to produce a mixed audio output signal. The processor is configured to transmit the mixed audio output signal to the amplifier and play, via the speaker, the mixed audio output signal, wherein the electronic control unit comprises a first functional safety level greater than or equal to a functional safety compliance threshold, and wherein the audio network interface, the vehicle network interface, the non-transitory memory, and the processor comprise the first functional safety level.

In this way, the electronic control unit mixes entertainment and infotainment related audio with functional safety-related notifications, and plays the mixed audio and notifications through the audio system of the vehicle. The electronic control unit is a functional safety compliant stand-alone component designed to adapt to a variety of automotive audio systems with minimal hardware or software changes. As a result, functional safety compliant ADAS operations are integrated into automotive audio systems, including non-FUSA automotive audio systems, thereby increasing the sound quality of functional safety-related notifications without burdening the audio system with FUSA upgrades.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 is a partial view of an exemplary interior of a cabin of a vehicle in accordance with one or more embodiments of the present disclosure;

FIG. 2 is a block diagram of an exemplary in-vehicle computing system of the vehicle of FIG. 1 in accordance with one or more embodiments of the present disclosure;

FIG. 3 is a block diagram of the vehicle of FIG. 1 including an example of a functional safety electronic control unit (ECU) configured to integrate ADAS operations with the audio system;

FIG. 4 is a block diagram depicting of an example of a functional safety ECU in accordance with one or more embodiments of the present disclosure;

FIG. 5 is a block diagram depicting a first example of the ECU of FIG. 4 integrating driver assistance operations with a first vehicle audio system in accordance with one or more embodiments of the present disclosure;

FIG. 6 is a block diagram depicting a second example of the ECU of FIG. 4 integrating driver assistance operations with a second vehicle audio system in accordance with one or more embodiments of the present disclosure;

FIG. 7 is a block diagram depicting a third example of the ECU of FIG. 4 integrating driver assistance operations with a third vehicle audio system in accordance with one or more embodiments of the present disclosure;

FIG. 8 is a block diagram depicting a fourth example of the ECU of FIG. 4 integrating driver assistance operations with a fourth vehicle audio system in accordance with one or more embodiments of the present disclosure; and

FIG. 9 is a flowchart of an example of a method for an ECU for a vehicle in accordance with one or more embodiments of the present disclosure.

### DETAILED DESCRIPTION

Examples will be provided below for illustration. The descriptions of the various examples will be presented for purposes of illustration, but are not intended to be exhaustive or limited to the embodiments. Many modifications and variations will be apparent to those of ordinary skill in the art without departing from the scope and spirit of the described embodiments.

The present disclosure provides systems and methods for adapting an audio system of a vehicle to play functional safety-related notifications using an electronic control unit that is functional safety compliant. The present disclosure includes an electronic control unit that includes an audio network interface configured to receive an audio input signal from a vehicle audio system, and includes a vehicle network interface configured to receive one or more vehicle signals from a sensor of the vehicle, such as an ADAS sensor. The electronic control unit includes non-transitory memory storing instructions and a processor communicably coupled to the audio network interface, the vehicle network interface, and the non-transitory memory. When executed, the instructions cause the electronic control unit to receive the audio input signal, receive the one or more vehicle signals, and generate a notification in response to the one or more vehicle signals. Via the processor of the electronic control unit, the notification is mixed with the audio input signal to produce a mixed audio output signal that is transmitted, via the audio network interface, to an amplifier of the vehicle audio system, and played one or more speakers of the vehicle audio system.

In some examples of the present disclosure, the electronic control unit is configured to adapt to a variety of vehicle audio systems, from basic grade to premium grade systems. The electronic control unit integrates with a head unit, one or more amplifiers, and one or more speakers of an audio system. Further, the electronic control unit may be configured to directly couple to speakers and other audio system components via one or more of tracking power supplier, a boosted integrated converter, and a non-boosted integrated converter. The electronic control unit may also be configured to feedback the mixed audio output signal to the head unit.

As the electronic control unit is functional safety compliant, the electronic control unit is designed with structures and processes that meet or exceed a functional safety compliance threshold that may be set for the functional safety level. For example, the audio network interface, the vehicle network interface, the processor, and other components, such as a power tree, may each meet or exceed the functional safety compliance threshold. However, in some examples, the audio system to which the electronic control unit adapts may not be functional safety compliant, or may be functional safety compliant at lower functional safety level. The technical advantage of the present disclosure lies in its ability its ability to integrate ADAS operations with a variety of audio systems. By using the disclosed electronic control unit, the approach increases the sound quality of functional safety-related notifications without the vehicle audio system itself being functional safety compliant.

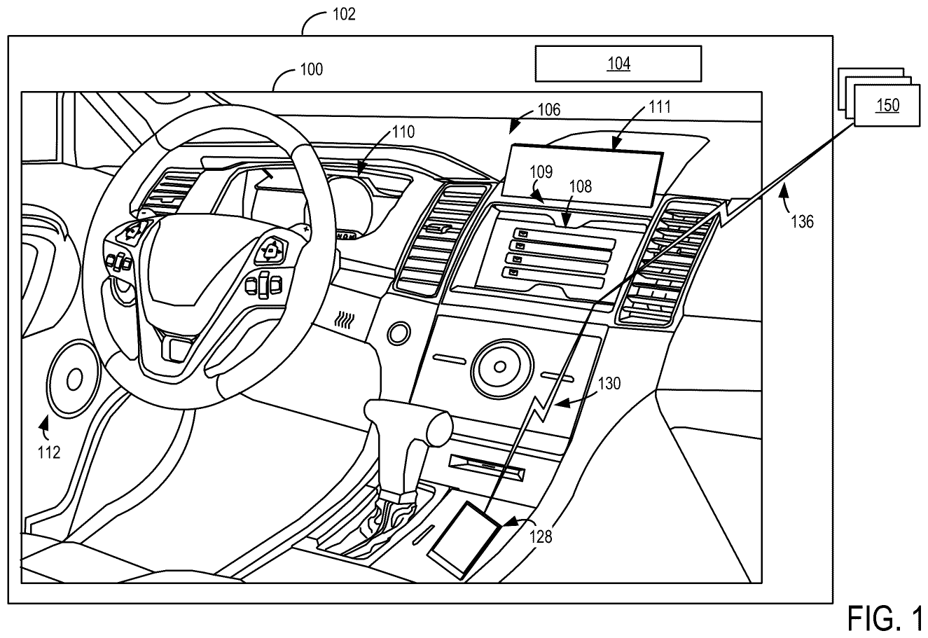

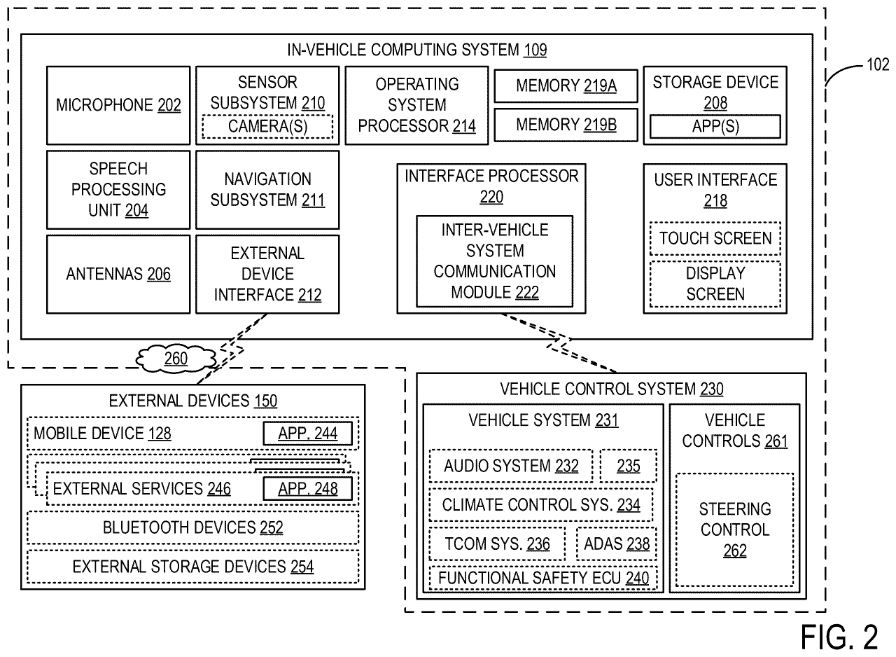

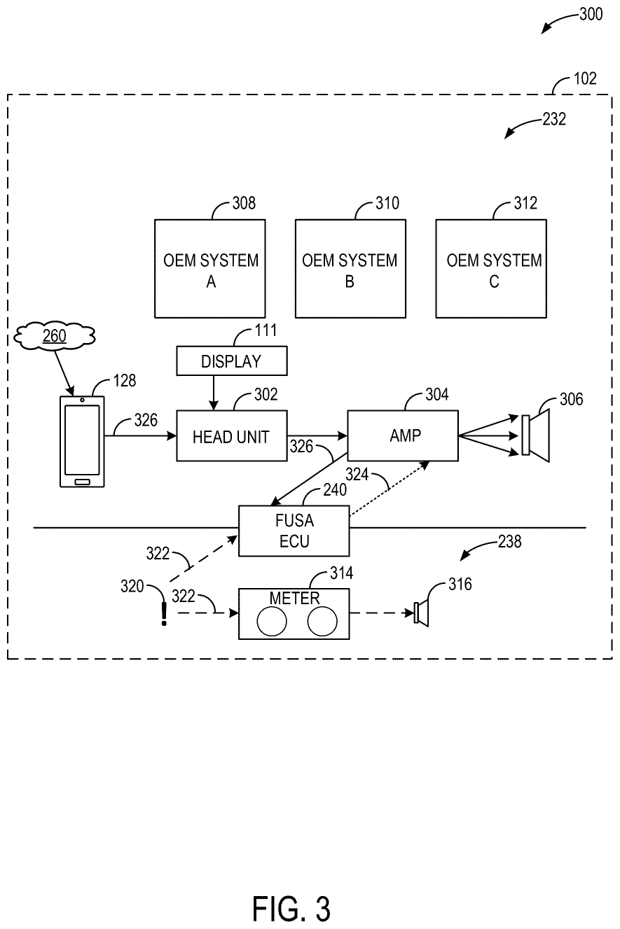

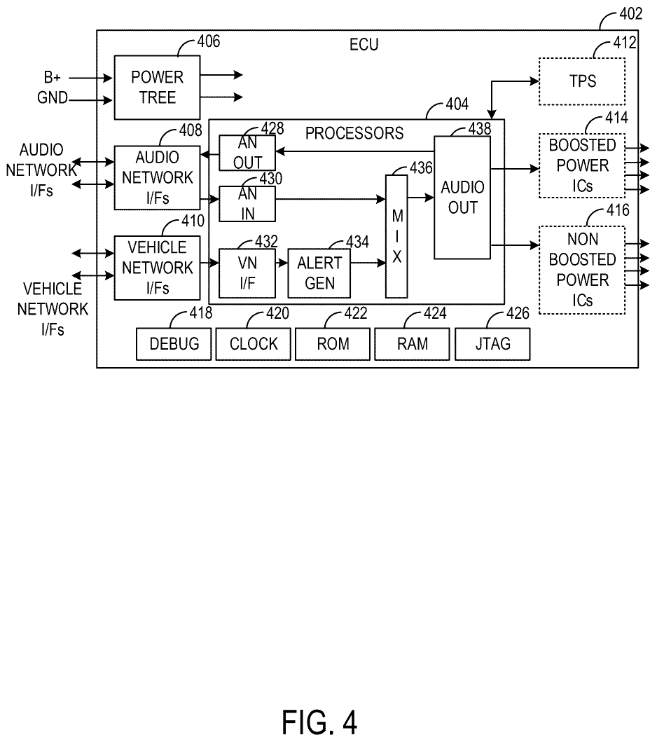

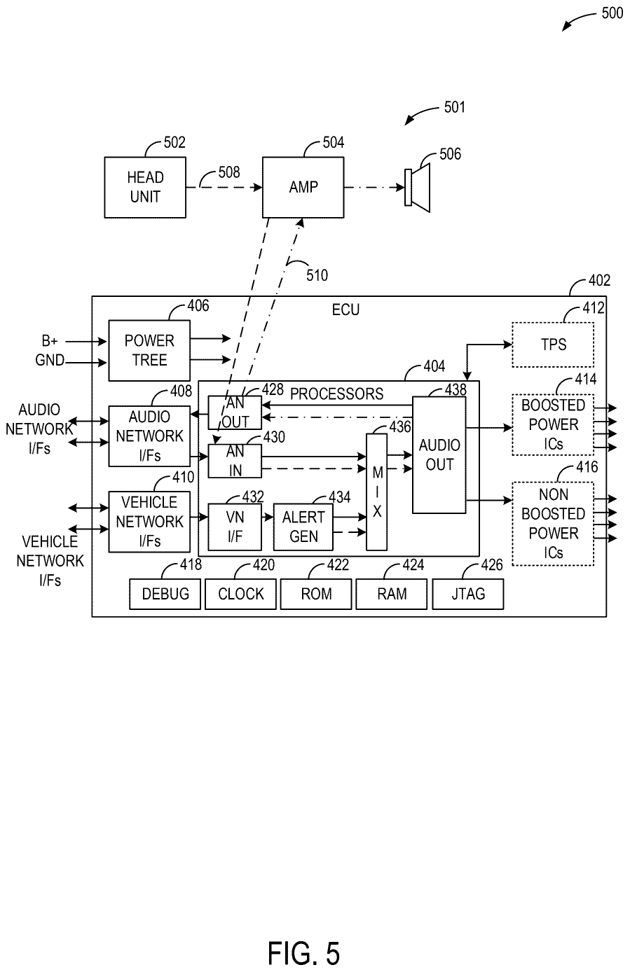

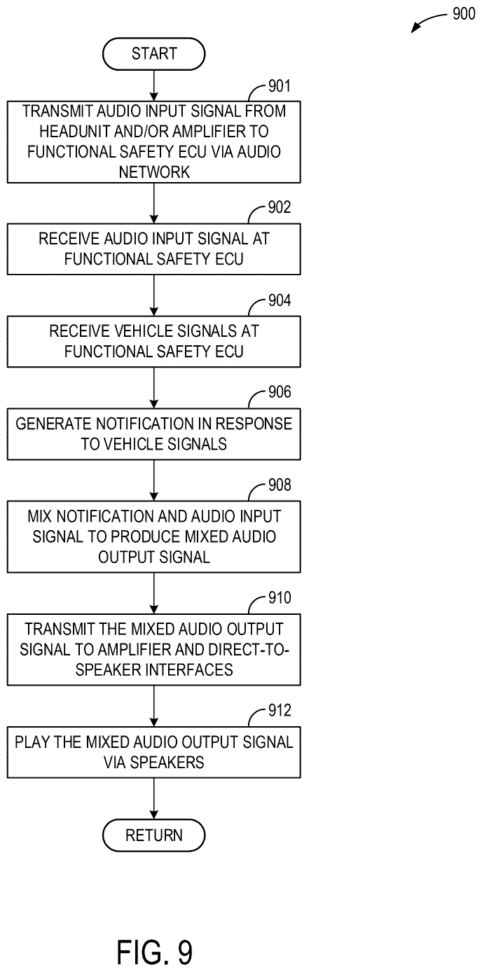

The approaches disclosed herein may be applicable in ADAS and audio systems for vehicles such as the vehicle shown in FIG. 1. At least some of the operations may be executed by, or in communication with, an infotainment system, such as the infotainment system shown in FIG. 2. A vehicle, such as the vehicle shown in FIG. 1, may include a functional safety ECU that is configured to integrate ADAS operations with the audio system, such as shown in FIG. 3. An example of a functional safety ECU is shown in FIG. 4. Examples of the ECU of FIG. 4 integrating ADAS operations with a variety of vehicle audio systems are shown in FIGS. 5-8. A method for a functional safety ECU, such the ECU shown in FIGS. 3-8, is outlined in the flowchart of FIG. 9.

FIG. 1 shows an example partial view of an interior of a cabin 100 of a vehicle 102, in which a driver and/or one or more passengers may be seated. Vehicle 102 of FIG. 1 may be a motor vehicle including drive wheels (not shown) and an internal combustion engine 104. Internal combustion engine 104 may include one or more combustion chambers which may receive intake air via an intake passage and exhaust combustion gases via an exhaust passage. Vehicle 102 may be a road automobile, among other types of vehicles. In some examples, vehicle 102 may include a hybrid propulsion system including an energy conversion device operable to absorb energy from vehicle motion and/or the engine and convert the absorbed energy to an energy form suitable for storage by an energy storage device. Vehicle 102 may include a fully electric vehicle, incorporating fuel cells, solar energy capturing elements, and/or other energy storage systems for powering the vehicle.

As shown, an instrument panel 106 may include various displays and controls accessible to a human driver (also referred to as the user) of vehicle 102. For example, instrument panel 106 may include a touch screen 108 of an in-vehicle computing system or infotainment system 109 (e.g., an infotainment system), an audio system control panel, and an instrument cluster 110 (also herein referred to as a meter). Touch screen 108 may receive user input to in-vehicle computing system or infotainment system 109 for controlling audio output, visual display output, user preferences, control parameter selection, and so on. While the example system shown in FIG. 1 includes audio system controls that may be performed via a user interface of in-vehicle computing system or infotainment system 109, such as touch screen 108 without a separate audio system control panel, in other embodiments, the vehicle may include an audio system control panel, which may include controls for a conventional vehicle audio system such as a radio, compact disc player, MP3 player, and so on. The audio system controls may include features for controlling one or more aspects of audio output via one or more speakers 112 of a vehicle speaker system. For example, the in-vehicle computing system or the audio system controls may control a volume of audio output, a distribution of sound among the individual speakers of the vehicle speaker system, an equalization of audio signals, and/or any other aspect of the audio output. In further examples, in-vehicle computing system or infotainment system 109 may adjust a radio station selection, a playlist selection, a source of audio input (e.g., from radio or CD or MP3), and so on, based on user input received directly via touch screen 108, or based on data regarding the user (such as a physical state and/or environment of the user) received via one or more external devices 150 and/or a mobile device 128. The audio system of the vehicle may include an amplifier (not shown) coupled to plurality of loudspeakers (not shown). In some embodiments, one or more hardware elements of in-vehicle computing system or infotainment system 109, such as touch screen 108, a display screen 111, various control dials, knobs and buttons, memory, processor(s), and any interface elements (e.g., connectors or ports) may form an integrated head unit that is installed in instrument panel 106 of the vehicle. The head unit may be fixedly or removably attached in instrument panel 106. In additional or alternative embodiments, one or more hardware elements of in-vehicle computing system or infotainment system 109 may be modular and may be installed in multiple locations of the vehicle.

Cabin 100 may include one or more sensors for monitoring the vehicle, the user, and/or the environment. For example, cabin 100 may include one or more cameras configured to monitor one or more vehicle occupants and the cabin, one or more seat-mounted pressure sensors configured to measure the pressure applied to the seat to determine the presence of a user, door sensors configured to monitor door activity, humidity sensors to measure the humidity content of the cabin, microphones to receive user input in the form of voice commands, to enable a user to conduct telephone calls, and/or to measure ambient noise in cabin 100, and so on. It is to be understood that the above-described sensors and/or one or more additional or alternative sensors may be positioned in any suitable location of the vehicle. For example, sensors may be positioned in an engine compartment, on an external surface of the vehicle, and/or in other suitable locations for providing information regarding the operation of the vehicle, ambient conditions of the vehicle, a user of the vehicle, and so on. Information regarding ambient conditions of the vehicle, vehicle status, or vehicle driver may also be received from sensors external to/separate from the vehicle (that is, not part of the vehicle system), such as sensors coupled to external devices 150 and/or mobile device 128.

Cabin 100 may also include one or more user objects, such as mobile device 128, that are stored in the vehicle before, during, and/or after travelling. Mobile device 128 may include a smart phone, a tablet, a laptop computer, a portable media player, and/or any suitable mobile computing device. Mobile device 128 may be connected to in-vehicle computing system via a communication link 130. Communication link 130 may be wired (e.g., via Universal Serial Bus (USB), Mobile High-Definition Link (MHL), High-Definition Multimedia Interface (HDMI), Ethernet, and so on) or wireless (e.g., via Bluetooth®, Wi-Fi®, Wi-Fi Direct®, Near-Field Communication (NFC), cellular connectivity, and so on) and configured to provide two-way communication between the mobile device and the in-vehicle computing system. (Bluetooth® is a registered trademark of Bluetooth SIG, Inc., Kirkland, WA. Wi-Fi® and Wi-Fi Direct® are registered trademarks of Wi-Fi Alliance, Austin, Texas.) Mobile device 128 may include one or more wireless communication interfaces for connecting to one or more communication links (e.g., one or more of the example communication links described above). The wireless communication interface may include one or more physical devices, such as antenna(s) or port(s) coupled to data lines for carrying transmitted or received data, as well as one or more modules/drivers for operating the physical devices in accordance with other devices in the mobile device. For example, communication link 130 may provide sensor and/or control signals from various vehicle systems (such as vehicle audio system, climate control system, and so on) and touch screen 108 to mobile device 128 and may provide control and/or display signals from mobile device 128 to the in-vehicle systems and touch screen 108. Communication link 130 may also provide power to mobile device 128 from an in-vehicle power source in order to charge an internal battery of the mobile device.

In-vehicle computing system or infotainment system 109 may also be communicatively coupled to additional devices operated and/or accessed by the user but located external to vehicle 102, such as one or more external devices 150. In the depicted embodiment, external devices are located outside of vehicle 102 though it will be appreciated that in alternate embodiments, external devices may be located inside cabin 100. The external devices may include a server computing system, personal computing system, portable electronic device, electronic wrist band, electronic head band, portable music player, electronic activity tracking device, pedometer, smart-watch, GPS system, and so on. External devices 150 may be connected to the in-vehicle computing system via a communication link 136 which may be wired or wireless, as discussed with reference to communication link 130, and configured to provide two-way communication between the external devices and the in-vehicle computing system. For example, external devices 150 may include one or more sensors and communication link 136 may transmit sensor output from external devices 150 to in-vehicle computing system or infotainment system 109 and touch screen 108. External devices 150 may also store and/or receive information regarding contextual data, user behavior/preferences, operating rules, and so on and may transmit such information from external devices 150 to in-vehicle computing system or infotainment system 109 and touch screen 108.

In-vehicle computing system or infotainment system 109 may analyze the input received from external devices 150, mobile device 128, and/or other input sources and select settings for various in-vehicle systems (such as climate control system or audio system), provide output via touch screen 108 and/or speakers 112, communicate with mobile device 128 and/or external devices 150, and/or perform other actions based on the assessment. In some embodiments, all or a portion of the assessment may be performed by mobile device 128 and/or external devices 150.

In some embodiments, one or more of external devices 150 may be communicatively coupled to in-vehicle computing system or infotainment system 109 indirectly, via mobile device 128 and/or another of external devices 150. For example, communication link 136 may communicatively couple external devices 150 to mobile device 128 such that output from external devices 150 is relayed to mobile device 128. Data received from external devices 150 may then be aggregated at mobile device 128 with data collected by mobile device 128, the aggregated data then transmitted to in-vehicle computing system or infotainment system 109 and touch screen 108 via communication link 130. Similar data aggregation may occur at a server system and then transmitted to in-vehicle computing system or infotainment system 109 and touch screen 108 via communication link 136 and/or communication link 130.

FIG. 2 shows a block diagram of an in-vehicle computing system or infotainment system 109 configured and/or integrated inside vehicle 102. In-vehicle computing system or infotainment system 109 may perform one or more of the methods described herein in some embodiments. In some examples, in-vehicle computing system or infotainment system 109 may be a vehicle infotainment system configured to provide information-based media content (audio and/or visual media content, including entertainment content, navigational services, and so on) to a vehicle user to enhance the operator's in-vehicle experience. In-vehicle computing system or infotainment system 109 may include, or be coupled to, various vehicle systems, sub-systems, hardware components, as well as software applications and systems that are integrated in, or integratable into, vehicle 102 in order to enhance an in-vehicle experience for a driver and/or a passenger. As disclosed herein, the infotainment system 109 may include a functional safety ECU that is configured to generate notifications, such as alert sounds, messages, or haptic feedback, in response to vehicle signals and play the notifications via the vehicle audio system according to the exemplary methods described herein.

In-vehicle computing system or infotainment system 109 may include one or more processors including an operating system processor 214 and an interface processor 220. Operating system processor 214 may execute an operating system on in-vehicle computing system or infotainment system 109, and control input/output, display, playback, and other operations of in-vehicle computing system or infotainment system 109. Interface processor 220 may interface with a vehicle control system 230 via an inter-vehicle system communication module 222.

Inter-vehicle system communication module 222 may output data to one or more other vehicle systems 231 and/or one or more other vehicle control elements 261, while also receiving data input from other vehicle systems 231 and other vehicle control elements 261, e.g., by way of vehicle control system 230. When outputting data, inter-vehicle system communication module 222 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as Global Positioning System (GPS) sensors, and so on), digital signals propagated through vehicle data networks (such as an engine controller area network (CAN) bus through which engine related information may be communicated, a climate control CAN bus through which climate control related information may be communicated, and a multimedia data network through which multimedia data is communicated between multimedia components in the vehicle). For example, in-vehicle computing system or infotainment system 109 may retrieve from the engine CAN bus the current speed of the vehicle estimated by the wheel sensors, a power state of the vehicle via a battery and/or power distribution system of the vehicle, an ignition state of the vehicle, and so on. In addition, other interfacing means such as Ethernet may be used as well without departing from the scope of this disclosure.

A storage device 208 may be included in in-vehicle computing system or infotainment system 109 to store data such as instructions executable by operating system processor 214 and/or interface processor 220 in non-volatile form. Storage device 208 may store application data, including prerecorded sounds, to enable in-vehicle computing system or infotainment system 109 to run an application for connecting to a cloud-based server and/or collecting information for transmission to the cloud-based server. The application may retrieve information gathered by vehicle systems/sensors, input devices (e.g., a user interface 218), data stored in one or more storage devices, such as a volatile memory 219A or a non-volatile memory 219B, devices in communication with the in-vehicle computing system (e.g., a mobile device connected via a Bluetooth® link), and so on. (Bluetooth® is a registered trademark of Bluetooth SIG, Inc., Kirkland, WA.) In-vehicle computing system or infotainment system 109 may further include a volatile memory 219A. Volatile memory 219A may be random access memory (RAM). Non-transitory storage devices, such as non-volatile storage device 208 and/or non-volatile memory 219B, may store instructions and/or code that, when executed by a processor (e.g., operating system processor 214 and/or interface processor 220), controls in-vehicle computing system or infotainment system 109 to perform one or more of the actions described in the disclosure.

One or more microphones 202 may be included in in-vehicle computing system or infotainment system 109 to receive voice commands from a user, to measure ambient noise in the vehicle, to determine whether audio from speakers of the vehicle is tuned in accordance with an acoustic environment of the vehicle, and so on. A speech processing unit 204 may process voice commands, such as the voice commands received from microphone 202. In some embodiments, in-vehicle computing system or infotainment system 109 may also be able to receive voice commands and sample ambient vehicle noise using a microphone included in an audio system 232 of the vehicle.

One or more additional sensors may be included in a sensor subsystem 210 of in-vehicle computing system or infotainment system 109. For example, sensor subsystem 210 may include a camera, such as a rear view camera for assisting a user in parking the vehicle and/or a cabin camera for identifying a user (e.g., using facial recognition and/or user gestures). Sensor subsystem 210 of in-vehicle computing system or infotainment system 109 may communicate with and receive inputs from various vehicle sensors and may further receive user inputs. For example, the inputs received by sensor subsystem 210 may include transmission gear position, transmission clutch position, gas pedal input, brake input, transmission selector position, vehicle speed, engine speed, mass airflow through the engine, ambient temperature, intake air temperature, and so on, as well as inputs from climate control system sensors (such as heat transfer fluid temperature, antifreeze temperature, fan speed, passenger compartment temperature, desired passenger compartment temperature, ambient humidity, and so on), an audio sensor detecting voice commands issued by a user, a fob sensor receiving commands from and optionally tracking the geographic location/proximity of a fob of the vehicle, and so on.

While certain vehicle system sensors may communicate with sensor subsystem 210 alone, other sensors may communicate with both sensor subsystem 210 and vehicle control system 230, or may communicate with sensor subsystem 210 indirectly via vehicle control system 230. A navigation subsystem 211 of in-vehicle computing system or infotainment system 109 may generate and/or receive navigation information such as location information (e.g., via a GPS sensor and/or other sensors from sensor subsystem 210), route guidance, traffic information, point-of-interest (POI) identification, and/or provide other navigational services for the driver.

An external device interface 212 of in-vehicle computing system or infotainment system 109 may be coupled to and/or communicate with one or more external devices 150 located external to vehicle 102. While the external devices are illustrated as being located external to vehicle 102, it is to be understood that they may be temporarily housed in vehicle 102, such as when the user is operating the external devices while operating vehicle 102. In other words, external devices 150 are not integral to vehicle 102. External devices 150 may include a mobile device 128 (e.g., connected via a Bluetooth®, NFC, WI-FI Direct®, or other wireless connection) or an alternate Bluetooth®-enabled device 252. (Wi-Fi Direct® is a registered trademark of Wi-Fi Alliance, Austin, Texas.)

Mobile device 128 may be a mobile phone, smart phone, wearable devices/sensors that may communicate with the in-vehicle computing system via wired and/or wireless communication, or other portable electronic device(s). Other external devices include one or more external services 246. For example, the external devices may include extra-vehicular devices that are separate from and located externally to the vehicle. Still other external devices include one or more external storage devices 254, such as solid-state drives, pen drives, Universal Serial Bus (USB) drives, and so on. External devices 150 may communicate with in-vehicle computing system or infotainment system 109 either wirelessly or via connectors without departing from the scope of this disclosure. For example, external devices 150 may communicate with in-vehicle computing system or infotainment system 109 through external device interface 212 over a network 260, a USB connection, a direct wired connection, a direct wireless connection, and/or other communication link.

External device interface 212 may provide a communication interface to enable the in-vehicle computing system to communicate with mobile devices associated with contacts of the driver. For example, external device interface 212 may enable phone calls to be established and/or text messages (e.g., Short Message Service (SMS), Multimedia Message Service (MMS), and so on) to be sent (e.g., via a cellular communications network) to a mobile device associated with a contact of the driver. External device interface 212 may additionally or alternatively provide a wireless communication interface to enable the in-vehicle computing system to synchronize data with one or more devices in the vehicle (e.g., the driver's mobile device) via Wi-Fi Direct®, as described in more detail below.

One or more applications 244 may be operable on mobile device 128. As an example, a mobile device application 244 may be operated to aggregate user data regarding interactions of the user with the mobile device. For example, mobile device application 244 may aggregate data regarding music playlists listened to by the user on the mobile device, telephone call logs (including a frequency and duration of telephone calls accepted by the user), positional information including locations frequented by the user and an amount of time spent at each location, and so on. The collected data may be transferred by application 244 to External device interface 212 over network 260. In addition, specific user data requests may be received at mobile device 128 from in-vehicle computing system or infotainment system 109 via external device interface 212. The specific data requests may include requests for determining where the user is geographically located, an ambient noise level and/or music genre at the user's location, an ambient weather condition (temperature, humidity, and so on) at the user's location, and so on. Mobile device application 244 may send control instructions to components (e.g., microphone, amplifier, and so on) or other applications (e.g., navigational applications) of mobile device 128 to enable the requested data to be collected on the mobile device or requested adjustment made to the components. Mobile device application 244 may then relay the collected information back to in-vehicle computing system or infotainment system 109.

Likewise, one or more applications 248 may be operable on external services 246. As an example, external services applications 248 may be operated to aggregate and/or analyze data from multiple data sources. For example, external services applications 248 may aggregate data from one or more social media accounts of the user, data from the in-vehicle computing system (e.g., sensor data, log files, user input, and so on), data from an internet query (e.g., weather data, POI data), and so on. The collected data may be transmitted to another device and/or analyzed by the application to determine a context of the driver, vehicle, and environment and perform an action based on the context (e.g., requesting/sending data to other devices).

Vehicle control system 230 may include controls for controlling aspects of various vehicle systems 231 involved in different in-vehicle functions. These may include, for example, controlling aspects of an ADAS 238 for monitoring the vehicle cabin and providing assistance to the driver or other vehicle occupants, aspects of vehicle audio system 232 for providing audio entertainment to the vehicle occupants, aspects of a climate control system 234 for meeting the cabin cooling or heating needs of the vehicle occupants, as well as aspects of a telecommunication system 236 for enabling vehicle occupants to establish telecommunication linkage with others.

Audio system 232 may include one or more acoustic reproduction devices including electromagnetic transducers such as one or more speakers 235. Vehicle audio system 232 may be passive or active such as by including a power amplifier. In some examples, in-vehicle computing system or infotainment system 109 may be a sole audio source for the acoustic reproduction device or there may be other audio sources that are connected to the audio reproduction system (e.g., external devices such as a mobile phone). The connection of any such external devices to the audio reproduction device may be analog, digital, or any combination of analog and digital technologies.

Climate control system 234 may be configured to provide a comfortable environment within the cabin or passenger compartment of vehicle 102. Climate control system 234 includes components enabling controlled ventilation such as air vents, a heater, an air conditioner, an integrated heater and air-conditioner system, and so on. Other components linked to the heating and air-conditioning setup may include a windshield defrosting and defogging system capable of clearing the windshield and a ventilation-air filter for cleaning outside air that enters the passenger compartment through a fresh-air inlet.

ADAS 238 may be communicatively coupled to one or more other systems of the vehicle 102 via the infotainment system 109. In one example, the non-volatile memory 219B of infotainment system 109 may store instructions that when executed cause the operating system processor 214 to execute one or more methods for vehicle operating conditions monitoring by the ADAS 238. For example, ADAS 238 may be configured to receive signals from one or more sensors of the sensor subsystem 210. In response to a signal operating outside of a threshold range, the operating system processor 214 may be configured to generate a notification, such as one or more of an alert tone, a spoken alert message, a chair vibration, a steering wheel vibration, and a lighting adjustment, and execute the notification via the ADAS 238 or other vehicle system.

The vehicle control system 230 may include a functional safety electronic control unit (ECU) 240 that is configured to generate notifications in response to vehicle signals and play the notifications through the vehicle audio system. The functional safety ECU 240 may comprise a plurality of functional safety features which render the functional safety ECU 240 a FUSA compliant device. Examples of an ECU are described in more detail below with reference to FIGS. 3-4. The functional safety ECU 240 may be communicably coupled to one or more other systems of the vehicle 102 via the infotainment system 109. As one example, the functional safety ECU 240 may be communicably coupled to one or more sensors of the sensor subsystem 210 and communicably coupled to the audio system 232. In some examples, the functional safety ECU 240 may be communicably coupled to one or more sensors of the sensor subsystem 210 via the ADAS 238. However, in other examples, the functional safety ECU 240 may be directly coupled to one or more sensors of the sensor subsystem 210.

Vehicle control system 230 may also include controls for adjusting the settings of various vehicle control elements 261 (or vehicle controls, or vehicle system control elements) related to the engine and/or auxiliary elements within a cabin of the vehicle, such as one or more steering wheel controls 262 (e.g., steering wheel-mounted audio system controls, cruise controls, windshield wiper controls, headlight controls, turn signal controls, and so on), instrument panel controls, microphone(s), accelerator/brake/clutch pedals, a gear shift, door/window controls positioned in a driver or passenger door, seat controls, cabin light controls, audio system controls, cabin temperature controls, and so on. Vehicle control elements 261 may also include internal engine and vehicle operation controls (e.g., engine controller module, actuators, valves, and so on) that are configured to receive instructions via the CAN bus of the vehicle to change operation of one or more of the engine, exhaust system, transmission, and/or other vehicle system. The control signals may also control audio output at one or more speakers 235 of vehicle audio system 232. For example, the control signals may adjust audio output characteristics such as volume, equalization, audio image (e.g., the configuration of the audio signals to produce audio output that appears to a user to originate from one or more defined locations), audio distribution among a plurality of speakers, and so on. Likewise, the control signals may control vents, air conditioner, and/or heater of climate control system 234. For example, the control signals may increase delivery of cooled air to a specific section of the cabin.

Control elements positioned on an outside of a vehicle (e.g., controls for a security system) may also be connected to in-vehicle computing system or infotainment system 109, such as via inter-vehicle system communication module 222. The control elements of vehicle control system 230 may be physically and permanently positioned on and/or in the vehicle for receiving user input. In addition to receiving control instructions from in-vehicle computing system or infotainment system 109, vehicle control system 230 may also receive input from one or more external devices 150 operated by the user, such as from mobile device 128. This allows aspects of vehicle systems 231 and vehicle control elements 261 to be controlled based on user input received from external devices 150.

In-vehicle computing system or infotainment system 109 may further include one or more antennas 206. The in-vehicle computing system may obtain broadband wireless internet access via antennas 206, and may further receive broadcast signals such as radio, television, weather, traffic, and the like. In-vehicle computing system or infotainment system 109 may receive positioning signals such as GPS signals via antennas 206. The in-vehicle computing system may also receive wireless commands via radio frequency (RF) such as via antennas 206 or via infrared or other means through appropriate receiving devices. In some embodiments, antenna 206 may be included as part of audio system 232 or telecommunication system 236. Additionally, antenna 206 may provide AM/FM radio signals to external devices 150 (such as to mobile device 128) via external device interface 212.

One or more elements of in-vehicle computing system or infotainment system 109 may be controlled by a user via user interface 218. User interface 218 may include a graphical user interface presented on a touch screen, such as touch screen 108 and/or display screen 111 of FIG. 1, and/or user-actuated buttons, switches, knobs, dials, sliders, and so on. For example, user-actuated elements may include steering wheel controls, door and/or window controls, instrument panel controls, audio system settings, climate control system settings, and the like. A user may also interact with one or more applications of in-vehicle computing system or infotainment system 109 and mobile device 128 via user interface 218. In addition to receiving a user's vehicle setting preferences on user interface 218, vehicle settings selected by in-vehicle control system 230 may be displayed to a user on user interface 218. Notifications and other messages (e.g., received messages), as well as navigational assistance, may be displayed to the user on a display of the user interface. User preferences/information and/or responses to presented messages may be performed via user input to the user interface.

Referring now to FIG. 3, a schematic diagram of a functional safety notification system 300 of a vehicle is shown. The system 300 integrates functional safety-related notifications with an audio system of the vehicle, which may be a non-limiting example of the vehicle 102 and systems thereof previously introduced with reference to FIGS. 1 and 2. The system 300 increases the fidelity of functional safety-related notifications without functional safety upgrades on the audio system. The notifications play through the audio system of the vehicle, integrated with the entertainment and infotainment amplification. In some examples, the functional safety notification system may produce clearer sounding notifications with less distortion, and more capacity for user control over loudness or other parameters of the audio system than an ADAS may otherwise provide.

The system 300 includes a head unit 302, a first amplifier 304, a first speaker 306, the ADAS 238, and the functional safety electronic control unit (ECU) 240. In the example, the head unit 302, the first amplifier 304, and the first speaker 306 are included in the audio system 232 of the vehicle 102. The system 300 may additionally, or alternatively, include one of an original equipment manufacturer (OEM) audio system A 308, OEM audio system B 310, and OEM audio system C 312. In one example, OEM audio system A 308, OEM audio system B 310, and OEM audio system C 312 may represent a range of audio system quality, complexity and/or cost. For example, the OEM audio system may include fewer, more, or better quality models of one or more of a plurality of amplifiers, a plurality of speakers, a plurality of excitors, a plurality of microphones, and other audio system components. The head unit 302 may communicatively couple to display 111, the mobile device 128 and the cloud 260, and other systems of vehicle 102.

As an example, a user may control the audio system 232 via the display 111 of the infotainment system 109 (e.g., in FIGS. 1-2). Additionally, or alternatively, the user may control the audio system 232 via a companion application (app) installed on the mobile device 128. Audio signals 326 transmitted from the infotainment system 109 and the mobile device 128 are processed by the head unit 302 and transmitted to the first amplifier 304. The amplified audio signals are played via one or more speakers, e.g., the first speaker 306, other speakers of the OEM, etc.

In the example, the ADAS 238 includes a meter 314 configured to receive a plurality of vehicle signals and one or more ADAS speakers 316. The ADAS 238 may include a processor and instructions, e.g., processor 214 and non-volatile memory 219B, that when executed cause the processor to generate a notification 322 in response to a sensor indication 320 of an operating condition operating outside of a threshold range. The threshold range may include a non-zero positive value lower threshold and a non-zero positive value upper threshold. In some examples, the meter 314 receives the vehicle signals or notification 322 from the ADAS 238, or may receive a notification from other ECUs. In response, the meter 314 may display a virtual view of the notification 322 or generate an alert sound via the ADAS speaker 316. Additionally, or alternatively, the notification 322 may play via the audio system 232 in coordination with the functional safety ECU 240. In some examples, such as in efficient and/or streamlined audio systems, the capacity of the meter 314 to play alerts via the ADAS speaker 316 may be omitted from the system. In other examples, the capacity of the meter 314 to play alerts via the ADAS speaker 316 may be maintained as a backup system for potential scenarios where communication between the audio system 232 and the functional safety ECU 240 is compromised.

The functional safety ECU 240 mixes the notification 322 with audio signals 326 generated via the audio system 232 and transmits a mixed signal 324 back to the first amplifier 304, which is then played via the first speaker 306. The ADAS 238, associated subsystems, including the meter 314 and the ADAS speaker 316, and the functional safety ECU 240 may be functional safety compliant. In other words, the ADAS 238, associated subsystems, and the functional safety ECU 240 are engineered to operate reliably at a determined functional safety level, including redundancies that enable system operation under compromised conditions. However, the audio system 232, may not be functional safety compliant, or may be functional safety compliant at a lower functional safety level and be subject to different functional safety requirements. In other words, the ECU 240, and hardware and software components comprising the ECU 240 may comprise a first functional safety level greater than or equal to a functional safety compliance threshold. Whereas, the audio system 232, and the components comprising the audio system 232, may comprise a second functional safety level less than the first functional safely level. The functional safety ECU 240 coordinates signals between the ADAS 238 and the audio system 232, increasing sound quality and control of ADAS-generated notifications without functional safety upgrading of the audio system. Examples of the functional safety ECU 240 are described in more detail below with reference to FIGS. 4-8.

In one example, the functional safety ECU 240 may be configured to execute a cyclic check of the status of the audio network (e.g., see below for exemplary audio networks and corresponding audio network interfaces). As one example, in an event where the audio system 232 has an issue (e.g., lost connection, the amplifier 304 cannot output sound, the speakers 306 cannot output sound, etc.), the functional safety ECU 240 may record the issue as a fault status, and communicate the fault status to the vehicle network. For example, the fault status may communicate that audio system play of functional safety notifications is compromised. In a few examples, as a result of the fault status, the vehicle system may execute a fault mitigation. As one example, the fault mitigation may include use of the meter 314 to display the ADAS alert, use the ADAS speaker 316 to play alert sounds, and use of the infotainment system 109 or existing I/Fs of the vehicle 102 to notify the user of the ADAS alert.

Referring to FIG. 4, a schematic diagram of an exemplary functional safety electronic control unit (ECU) 402 is shown, which may be a non-limiting example of the functional safety ECU 240 described above with reference the functional safety notification system 300 of the vehicle 102 in FIGS. 2-3. Solid arrows depict signal pathways between structures of the ECU 402.

The ECU 402 includes one or more processors 404, a power tree 406, one or more audio network interfaces 408, and one or more vehicle network interfaces 410. In one example, the one or more processors 404 may comprise an integrated circuit such as, but not limited to, an SoC (System on Chip) or MCU+DSP (Microcontroller Unit and Digital System Processor). The power tree 406 generates power for the ECU 402 and includes connections to an external power supply. For example, the power tree 406 may include a connection to a positive power supply, such as 12V, and ground. The one or more audio network interfaces 408 are configured to receive an audio input signal from an audio system of a vehicle, such as the audio system 232 of vehicle 102 described above with reference to FIGS. 1-3. The one or more audio network interfaces 408 may operate based on one or more compatible in-vehicle communication and data transmission technologies, such as, but not limited to, A2B (Automotive Audio Bus), eMOST (Enhanced Media Oriented Systems Transport), INICnet (Intelligent Network Interface Controller, or Ethernet. The one or more vehicle network interfaces 410 are configured to receive one or more vehicle signals from one or both of vehicle sensors and an ADAS and related ECU of a vehicle, such as the sensors of ADAS 238 of vehicle 102 described above with reference to FIGS. 2-3. The one or more vehicle network interfaces 410 may operate based on one or more compatible automotive networking communication protocols, such as, but not limited to CAN (controller area network), LIN (local interconnect network), FlexRay, CXPI (controller area network physical interface), or Ethernet.

The ECU 402 includes a plurality of features which contribute to functional safety compliance. In one example, a first FUSA level may be set for the ECU 402. Hardware and software components of the ECU 402 may be selected, combined, and connected to the ECU 402 to meet on the first FUSA level. In other words, the FUSA level may comprise a functional safety compliance threshold, which may be set for the ECU 402, and the hardware and software components of the ECU 402 may be designed to meet or exceed the functional safety compliance threshold. For example, the FUSA level may be a functional safety compliance threshold that is determined based on specifics of the project. For example, the processors 404, the power tree 406, the audio network IFs 408, the vehicle network IFs 410, and so on, may meet or exceed the functional safety compliance threshold by including features, such as, but not limited to, Power On Reset, Brown Out Reset, Cyclical Redundancy Check, Windowed Watchdog Timer, HW/SW (hardware/software) module self-test, and run time status check to detect faults, and further include fault handling methods. For example, the one or more processors 404, the one or more audio network interfaces 408, the one or more vehicle network interfaces 410, and the power tree 406 may each be configured for fault detection, safe state recovery, and mitigation of faults and malfunctions. The functional safety achieving features of the ECU 402 support reliable ADAS operations through a variety of conditions without demanding FUSA compliance of the components with to which the ECU 402 may be communicably coupled.

In some examples, the ECU 402 may include one or more TPS (tracking power supplier) 412, boosted power ICs (integrated converters) 414, and non-boosted power ICs 416 that coordinate signal transfer between the ECU 402 and OEM audio system components. By incorporating one or more of the TPS 412, the boosted power ICs 414, and the non-boosted power ICs 416, the ECU 402 may be compatible with a range of OEM audio systems with minimal additional intervention. The ECU 402 may further include a debug pin interface 418, a clock 420, memory including ROM 422 and RAM 424, JTAG 426, and other components, where each component comprises the first FUSA level (e.g., meets or exceeds the functional safety compliance threshold). Further, the design of each component, including circuitry, software, and control methods, meet the first FUSA level as well.

The one or more processors 404 may include an audio network output channel 428, an audio network input channel 430, a vehicle network interface channel 432, an alert generator 434, a mixer 436, and an audio output channel 438. The processors 404 are configured to meet the requirements of the first FUSA level. Additionally, internal OS, software library, and applications of the processors 400 also comply with the requirements of the first FUSA level. For example, various software modules of the processors 404 may include self-test features and capabilities to test and check internal and external components at runtime. For example, the self-test features and capabilities may include testing CPU registers, SDRAM, and ROM access during startup, as well as conducting runtime checks. The memory of the one or more processors 404 may include instructions that when executed cause the one or more processors 404 to receive, via the audio network input channel 430, an audio input signal and receive, via the vehicle network interface channel 432, one or more vehicle signals. The instructions may further cause the one or more processors 404 to generate, via the alert generator 434, an alert or notification in response to the one or more vehicle signals. In one example, the alert generator 434 may generate a sound in response to the vehicle signals. Additionally, or alternatively, the alert generator 434 may generate feedback vibration or lighting adjustment in response to the vehicle signals. The instructions may further cause the one or more processors 404 to mix, via the mixer 436, the audio input signal and the notification to produce a mixed audio output signal. The instructions may further cause the one or more processors 404 to transmit, via one or both of the audio network output channel 428 and the audio output channel 438, the mixed audio output signal to the audio system of the vehicle. In some examples, the instructions may further cause the one or more processors 404 to transmit, via the audio output channel 438, the mixed audio output signal directly to speakers and other components of a vehicle audio system via one or more of the TPS 412, boosted power ICs 414, and non-boosted power ICs 416.

The ECU 402 may comprise an add-on component that may be installed in a vehicle to integrate function safety-related sound and/or shaker alerting operation with entertainment and infotainment sounds played through the vehicle audio system. By installing the ECU 402, the sound quality of driver alert operations may be improved, without demanding functional safety upgrades on the audio system. The ECU 402 adapts to a variety of OEM audio suppliers, including branded and non-branded amplifier suppliers. The ECU 402 is designed to mix in the function safety-related sound and/or shaker alerting on a digital audio bus, or output to a speaker directly, to join existing audio systems easily.

FIG. 5 is a block diagram depicting a first vehicle system 500 including the ECU 402 of FIG. 4 and a first audio system 501. Components of the ECU 402 introduced above with reference to FIG. 4 will not be reintroduced. The first audio system 501 includes a first head unit 502, a first amplifier 504, and a first plurality of speakers 506. In some examples, the first audio system 501 may include a plurality of amplifiers, woofers, tweeters, mid-range drivers, excitors, microphones, or other audio system components. Dashed line 508 shows an input signal pathway and dot dash line 510 shows an output signal pathway.

An audio input signal is processed via the first head unit 502 and transmitted to the first amplifier 504. The processors 404 receive an amplified audio input signal via the audio network input channel 430. The processors 404 receive one or more vehicle signals via the vehicle network interface channel 432, and in response, generate a notification via the alert generator 434. The notification is mixed with the audio input signal at the mixer 436 to produce a mixed audio output signal, shown by the dot-dash line. The mixed audio output signal is transmitted to the audio output channel 438, and to the audio network output channel 428. The mixed audio output signal is transmitted back to the first amplifier 504 where it is boosted and transmitted to and played via the first plurality of speakers 506. In this way, the ECU 402 mixes driver assistance notifications with entertainment and infotainment audio generated by the first audio system 501 using the first amplifier 504 to output the mixed signal.

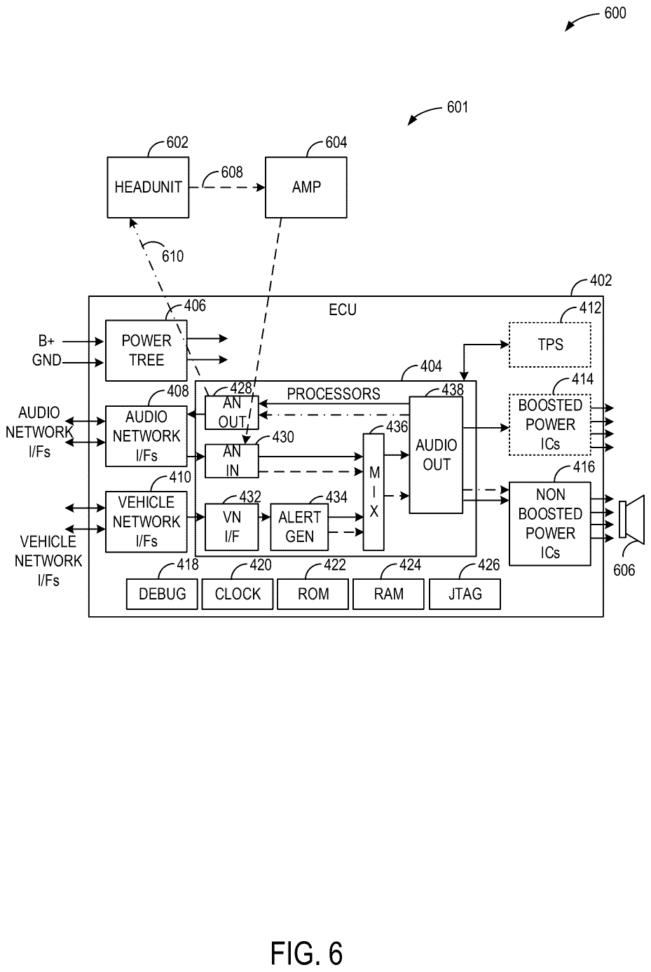

FIG. 6 is a block diagram depicting a second vehicle system 600 including the ECU 402 of FIG. 4 and a second audio system 601. The second audio system 601 may be an example of a base or standard grade OEM audio system. Components of the ECU 402 introduced above with reference to FIG. 4 will not be reintroduced. The second audio system 601 includes a second head unit 602, a second amplifier 604, and a second plurality of speakers 606. In one example, the second plurality of speakers 606 may communicably couple to the ECU 402 via the non-boosted power ICs 416. In some examples, the second audio system 601 may include a plurality of audio system components, including amplifiers, woofers, tweeters, mid-range drivers, excitors, microphones, and so on. Dashed line 608 shows an audio input signal pathway and dot-dash line 610 shows an audio output signal pathway.

An audio input signal is processed via the second head unit 602 and transmitted to the second amplifier 604. The processors 404 receive an amplified audio input signal via the audio network input channel 430. The processors 404 receive a sensor signal via the vehicle network interface channel 432, and in response, generate a notification via the alert generator 434. The notification is mixed with the audio input signal at the mixer 436 to produce a mixed audio output signal, shown by the dot-dash line 610. The mixed audio output signal is transmitted from the audio output channel 438 directly to the second plurality of speakers 606 via the non-boosted power ICs 416. At the same time, the mixed audio output signal is transmitted to the second head unit 602 (e.g., feedback sound) via the audio output channel 438, and to the audio network output channel 428. The mixed audio output signal is transmitted back to the second amplifier 604 where it is boosted and transmitted to back to the ECU 402. As shown in the example, the ECU 402 is compatible with a variety of audio systems, including base grade OEM systems, where the mixed audio signal is output to speakers directly and can feedback sound to the head unit.

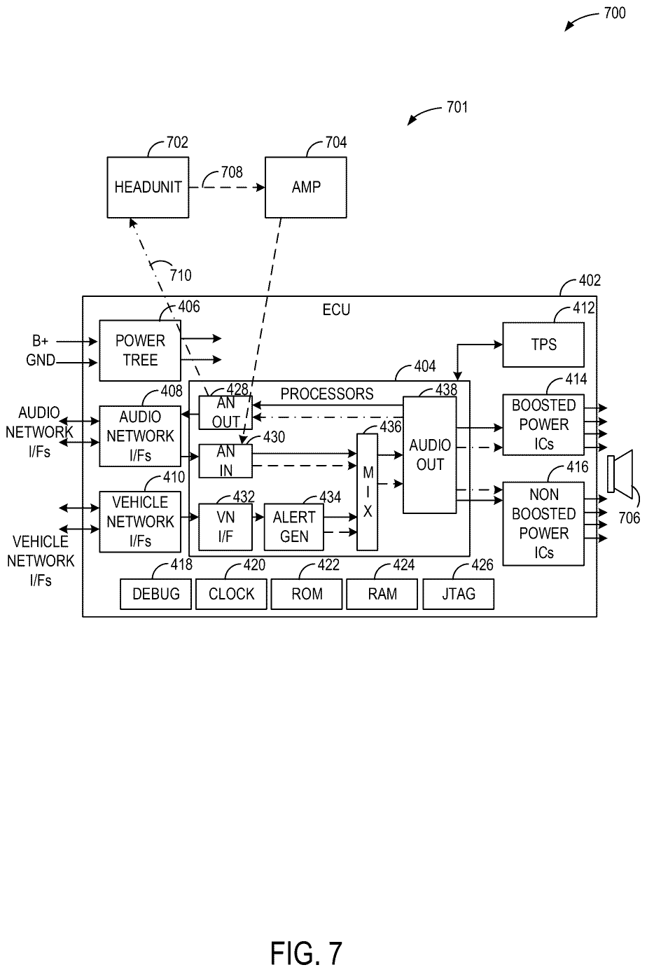

FIG. 7 is a block diagram depicting a third vehicle system 700 including the ECU 402 of FIG. 4 and a third audio system 701. The third audio system 701 may be an example of a middle grade OEM audio system. Components of the ECU 402 introduced above with reference to FIG. 4 will not be reintroduced. The third audio system 701 includes a third head unit 702, a third amplifier 704, and a third plurality of speakers 706. In one example, the third plurality of speakers 706 may communicably couple to the ECU 402 via the TPS 412, the non-boosted power ICs 416, and boosted power ICs 414. In some examples, the third audio system 701 may include a plurality of amplifiers, woofers, tweeters, mid-range drivers, excitors, microphones, and so on. Dashed line 708 shows an input signal pathway and dot-dash line 710 shows an output signal pathway.

The audio input signal is processed via the third head unit 702 and transmitted to the third amplifier 704. The processors 404 receive the amplified audio input signal via the audio network input channel 430. The processors 404 receive one or more vehicle signals via the vehicle network interface channel 432, and in response, generate a notification via the alert generator 434. The notification is mixed with the audio input signal at the mixer 436 to produce a mixed audio output signal, shown by the dot-dash line 710. The mixed audio output signal is transmitted from the audio output channel 438 directly to the third plurality of speakers 706 via the boosted power ICs 414 and the non-boosted power ICs 416. At the same time, the mixed audio output signal is transmitted to the third head unit 702 (e.g., feedback sound) via the audio output channel 438, and to the audio network output channel 428. The mixed audio output signal is transmitted back to the third amplifier 704 where it is boosted and transmitted to back to the ECU 402. Additionally, the processor 404 may control the TPS 412 to adjust the mixed audio output signal to the third amplifier 704. As shown in the example, the ECU 402 is compatible with a variety of audio systems, including middle grade OEM systems, where the mixed audio signal is output to boosted power and non-boosted power-coupled speakers directly, adjusted by the TPS, and feeds back sound to the head unit.

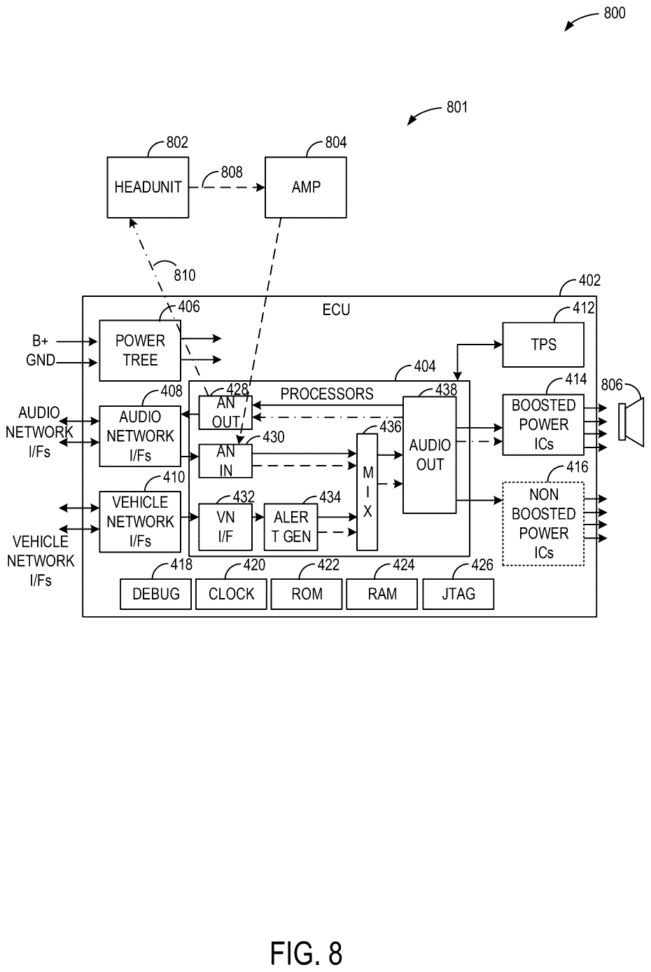

FIG. 8 is a block diagram depicting a fourth vehicle system 800 including the ECU 402 of FIG. 4 and a fourth audio system 801. The fourth audio system 801 may be an example of a premium grade OEM audio system. Components of the ECU 402 introduced above with reference to FIG. 4 will not be reintroduced. The fourth audio system 801 includes a fourth head unit 802, a fourth amplifier 804, and a fourth plurality of speakers 806. In one example, the fourth plurality of speakers 806 may communicably couple to the ECU 402 via the boosted power ICs 414. In some examples, the fourth audio system 801 may include a plurality of amplifiers, woofers, tweeters, mid-range drivers, excitors, microphones, and so on. Dashed line 808 shows an input signal pathway and dot-dash line 810 shows an and output signal pathway.

The audio input signal is processed via the fourth head unit 802 and transmitted to the fourth amplifier 804. The processors 404 receive the amplified audio input signal via the audio network input channel 430. The processors 404 receive one or more vehicle signals via the vehicle network interface channel 432, and in response, generate a notification via the alert generator 434. The notification is mixed with the audio input signal at the mixer 436 to produce a mixed audio output signal, shown by the dot-dash line. The mixed audio output signal is transmitted from the audio output channel 438 directly to the fourth plurality of speakers 806 via the boosted power ICs 414. At the same time, the mixed audio output signal is transmitted to the fourth head unit 802 (e.g., feedback sound) via the audio output channel 438, and to the audio network output channel 428. The mixed audio output signal is transmitted back to the fourth amplifier 804 where it is boosted and transmitted to back to the ECU 402. The ECU 402 may include instructions that when executed by the processors 404, cause the processors 404 to control the TPS 412 and driver audio and signal output to the boosted power ICs 414 to achieve high fidelity audio performance. As shown in the example, the ECU 402 is compatible with a variety of audio systems, including premium grade model OEM systems, where the mixed audio signal is output to boosted power-coupled speakers directly and can feedback sound to the head unit.

FIG. 9 shows a method 900 for integrating driver assistance operations with an audio system for a vehicle, such as the audio system 232 of vehicle 102 of FIGS. 1-3. The method 900 may be carried out by one or more processors of a functional safety ECU based on instructions stored in a memory of the functional safety ECU, such as the one or more processors 404 of the ECU 402 based on instructions stored in the memory of RAM 424 of FIG. 4. In one example, the functional safety ECU may coordinate operations with one or more processors of the vehicle based on instructions stored in a memory of the vehicle, such as the operating system processor 214 based on instructions stored in the memory of the vehicle 102 of FIGS. 1-3.

At 901, the method 900 includes transmitting an audio input signal from one of a head unit and an amplifier to the functional safety ECU via an audio network of the vehicle. In some examples, the head unit and the amplifier may be one of the head units and amplifiers described above with reference to FIGS. 1-3, 5-7. The audio input signal may be a signal transmitted from the head unit or the amplifier through a wired or wireless connection. The method may include amplifying the audio input signal and may undergo additional processing, such as equalization and filtering.

At 902, the method 900 includes receiving the audio input signal at the functional safety ECU. For example, the functional safety ECU may include one or more audio network interfaces, such as the audio network interfaces 408 described above with reference to FIG. 4. The input signal is transmitted to the functional safety ECU via the one or more audio network interfaces. The audio input signal is transmitted to the one or more processors of the functional safety ECU via one or more audio input channels communicatively coupled to the one or more audio network interfaces.

At 904, the method 900 includes receiving one or more vehicle signals at the functional safety ECU. For example, the functional safety ECU may include one or more vehicle network interfaces, such as the vehicle network interfaces 410 described above with reference to FIG. 4. The vehicle signals are transmitted to the one or more processors of the functional safety ECU via one or more vehicle network interface channels communicatively coupled to the vehicle network interfaces. In some examples, the vehicle signals are produced by one or more sensors directly coupled to the functional ECU. In other examples, the vehicle signals are produced by one or more sensors of an ADAS communicably coupled to the ECU, such as ADAS 238 of FIGS. 2-3. For example, the vehicle signals may include one or more ADAS signals, the one or more ADAS signals generated in response to ADAS detection of a vehicle operating condition operating outside of a threshold range. For example, the ADAS may monitor eye blinking for drowsiness monitoring, vehicle speed, vehicle control, driving time, objects in the vehicle path, etc., and produce one or more vehicle signals in response to one of the aforementioned operating conditions operating outside of the threshold range.

At 906, the method 900 includes generating a notification in response to receiving the vehicle signals. In some examples, the notification may include an audio signal, such as an alert tone or an audio message. In other examples, additionally, or alternatively, the notification may include one or more of feedback vibration, such as a shaker alert of a steering wheel or car seat, or lighting adjustment.

At 908, the method 900 includes mixing the notification and the audio input signal to produce a mixed audio output signal. As one example, the mixing may include one or more of sampling the input audio signal and the notification signal, prioritization, level adjustment, panning, weighting, and summing the signals into a mixed audio output signal. In one example, mixing may be based on specifics of the project. For example, during alert generation, mixing may include muting all audio input. As another example, during alert generation, mixing may include setting all audio input to a predefined low gain level, e.g., a first lower threshold gain. As yet another example, during alert generation, the mixing may include muting driver seat surround audio. As another example, during alert generation, the mixing may include setting driver seat surround audio to predefined low gain level, e.g., a second lower threshold gain.

At 910, the method 900 includes transmitting the mixed audio output signal to one or both of the one or more amplifiers and direct-to-speaker power ICs. As one example, in audio systems where one or more speakers are connected to the head unit via the amplifier, such as shown in FIG. 5, the mixed audio output signal may be transmitted from the functional safety ECU to the amplifier, and from the amplifier to one or more speakers. For example, the mixed audio output signal may be transmitted from the audio output channel of the ECU processor to the amplifier via the one or more audio network interfaces of the functional safety ECU. As another example, additionally, or alternatively, in audio systems where speakers are connected to the amplifier via one or more of TPS, boosted power ICs, and non-boosted power ICs, such shown in FIGS. 6-8, the mixed audio output signal may be transmitted from the functional safety ECU directly to speakers through one or more corresponding TPS, boosted power ICs, and non-boosted power ICs. Additionally, or alternatively, the mixed audio output signal may be fed back to the head unit, such shown in FIGS. 6-8.

At 912, the method 900 includes playing the mixed audio output signal via the speakers.

In some examples, the method may include monitoring the head unit, the amplifier, and audio network status. The method may include confirming transmission of both of the audio input signal and the mixed audio output signal. In response, to an indication of transmission fault, the method may include generating a fault message and executing fault mitigation. Fault mitigation may include one or more of displaying the notification via an advanced driver assistance system (ADAS) meter, playing the notification via an ADAS speaker, and generating the notification via an infotainment system. The method may include continuously monitoring for signal transmission between the audio network, the head unit, and the amplifier, and in response to an indication of restored transmission, operating the functional safety ECU to play notifications via the audio system of the vehicle.

In this way, the disclosed functional safety electronic control unit integrates functional safety-related notifications with an audio system of a vehicle. The achieved effect may include increased fidelity and audio quality control of functional safety-related notifications without direct upgrades to the audio system. The functional safety electronic control unit may adapt to a variety of audio systems, such as OEM audio systems, ranging from standard to premium audio systems.

The disclosure also provides support for an electronic control unit for a vehicle comprising: an audio network interface configured to receive an audio input signal, a vehicle network interface configured to receive one or more vehicle signals, a non-transitory memory storing instructions, and a processor communicably coupled to the audio network interface, the vehicle network interface, and the non-transitory memory, the processor, when executing the instructions, configured to: receive the audio input signal, receive the one or more vehicle signals, generate a notification in response to the one or more vehicle signals, mix the notification and the audio input signal to produce a mixed audio output signal, transmit, via the audio network interface, the mixed audio output signal to an amplifier, and play the mixed audio output signal via a speaker, wherein the electronic control unit comprises a first functional safety level greater than or equal to a functional safety compliance threshold. In a first example of the system, the audio network interface, the vehicle network interface, the non-transitory memory, and the processor comprise the first functional safety level. In a second example of the system, optionally including the first example, the processor, when executing the instructions, further configured to execute one or more of power on reset, brown out reset, cyclical redundancy check, windowed watchdog timer, hardware module self-test, software module self-test, and run time status check. In a third example of the system, optionally including one or both of the first and second examples, the system further comprises: a power tree comprising the first functional safety level. In a fourth example of the system, optionally including one or more or each of the first through third examples, the amplifier comprises a second functional safety level less than the functional safety compliance threshold. In a fifth example of the system, optionally including one or more or each of the first through fourth examples, the speaker comprises a second functional safety level less than the functional safety compliance threshold. In a sixth example of the system, optionally including one or more or each of the first through fifth examples the processor further configured to: transmit, via an audio output channel, the mixed audio output signal to one or more of a tracking power supplier, a boosted integrated converter, a non-boosted integrated converter, and transmit, via the audio network interface, the mixed audio output signal to a head unit. In a seventh example of the system, optionally including one or more or each of the first through sixth examples, the notification comprises an audio signal. In a eighth example of the system, optionally including one or more or each of the first through seventh examples, the notification further comprises one or both of a feedback vibration and a lighting adjustment. In a ninth example of the system, optionally including one or more or each of the first through eighth examples, the one or more vehicle signals comprise one or more advanced driver-assistance system (ADAS) signals, the one or more ADAS signals generated in response to ADAS detection of a vehicle operating condition operating outside of a threshold range.

The disclosure also provides support for a method for an electronic control unit for a vehicle comprising: receiving, via one or both of a head unit and an amplifier, an audio input signal, receiving, via an advanced driver-assistance (ADAS) system, one or more vehicle signals, generating a notification in response to the one or more vehicle signals, mixing the notification and the audio input signal to produce a mixed audio output signal, transmitting the mixed audio output signal to the amplifier, and playing, via a speaker, the mixed audio output signal, wherein the electronic control unit comprises a first functional safety level greater than or equal to a functional safety compliance threshold. In a first example of the method, the method further comprises: monitoring the head unit, the amplifier, and audio network status, confirming transmission of both of the audio input signal and the mixed audio output signal, in response to an indication of transmission fault, generating a fault message, and, executing fault mitigation. In a second example of the method, optionally including the first example, the fault mitigation comprises one or more of displaying the notification via an advanced driver assistance system (ADAS) meter, playing the notification via an ADAS speaker, and generating the notification via an infotainment system. In a third example of the method, optionally including one or both of the first and second examples, one or both of the amplifier and the speaker comprise a second functional safety level less than the functional safety compliance threshold. In a fourth example of the method, optionally including one or more or each of the first through third examples, the method further comprises: transmitting, via an audio output channel, the mixed audio output signal to one or more of a tracking power supplier, a boosted integrated converter and a non-boosted integrated converter, and transmitting, via an audio network interface, the mixed audio output signal to the head unit communicatively coupled to the amplifier. In a fifth example of the method, optionally including one or more or each of the first through fourth examples, the notification comprises one or more of an audio signal, feedback vibration and lighting adjustment.

The disclosure also provides support for a system for a vehicle, comprising: a head unit, an amplifier, a speaker, an advanced driver-assistance system (ADAS), and an electronic control unit communicably coupled to the head unit, the amplifier, the speaker, and the ADAS, the electronic control unit comprising: an audio network interface configured to receive an audio input signal from the head unit via the amplifier, a vehicle network interface configured to receive one or more vehicle signals from the ADAS, a non-transitory memory storing instructions, and a processor communicably coupled to the audio network interface, the vehicle network interface, and the non-transitory memory, the processor, when executing the instructions, configured to: receive the audio input signal, receive the one or more vehicle signals, generate a notification in response to the one or more vehicle signals, mix the notification and the audio input signal to produce a mixed audio output signal, transmit the mixed audio output signal to the amplifier, and play, via the speaker, the mixed audio output signal, wherein the electronic control unit comprises a first functional safety level greater than or equal to a functional safety compliance threshold, and wherein the audio network interface, the vehicle network interface, the non-transitory memory, and the processor comprise the first functional safety level. In a first example of the system, one or both of the amplifier and the speaker comprise a second functional safety level less than the functional safety compliance threshold. In a second example of the system, optionally including the first example the processor further configured to: transmit, via an audio output channel, the mixed audio output signal to one or more of a tracking power supplier, a boosted integrated converter and a non-boosted integrated converter, and, transmit, via the audio network interface, the mixed audio output signal to the head unit. In a third example of the system, optionally including one or both of the first and second examples, the processor, when executing the instructions, further configured to execute one or more of power on reset, brown out reset, cyclical redundancy check, windowed watchdog timer, hardware module self-test, software module self-test, and run time status check.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the infotainment system 109 described with reference to FIGS. 1 and 2, and one of the functional safety electronic control unit 240 described with reference to FIGS. 1 and 3 or the functional safety electronic control unit 402 described with reference to FIGS. 4-8. The methods may be performed by executing stored instructions with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. An electronic control unit for a vehicle comprising:
an audio network interface configured to receive an audio input signal;
a vehicle network interface configured to receive one or more vehicle signals;
a non-transitory memory storing instructions; and
a processor communicably coupled to the audio network interface, the vehicle network interface, and the non-transitory memory, the processor, when executing the instructions, configured to:
receive the audio input signal;
receive the one or more vehicle signals;
generate a notification in response to the one or more vehicle signals;
mix the notification and the audio input signal to produce a mixed audio output signal;
transmit, via the audio network interface, the mixed audio output signal to an amplifier; and
play the mixed audio output signal via a speaker,
wherein the electronic control unit comprises a first functional safety level greater than or equal to a functional safety compliance threshold.

2. The electronic control unit of claim 1, wherein the audio network interface, the vehicle network interface, the non-transitory memory, and the processor comprise the first functional safety level.

3. The electronic control unit of claim 1, wherein the processor, when executing the instructions, further configured to execute one or more of power on reset, brown out reset, cyclical redundancy check, windowed watchdog timer, hardware module self-test, software module self-test, and run time status check.

4. The electronic control unit of claim 1, wherein further comprising a power tree comprising the first functional safety level.

5. The electronic control unit of claim 1, wherein the amplifier comprises a second functional safety level less than the functional safety compliance threshold.

6. The electronic control unit of claim 1, wherein the speaker comprises a second functional safety level less than the functional safety compliance threshold.

7. The electronic control unit of claim 1, the processor further configured to:
transmit, via an audio output channel, the mixed audio output signal to one or more of a tracking power supplier, a boosted integrated converter, a non-boosted integrated converter; and
transmit, via the audio network interface, the mixed audio output signal to a head unit.

8. The electronic control unit of claim 1, wherein the notification comprises an audio signal.

9. The electronic control unit of claim 8, wherein the notification further comprises one or both of a feedback vibration and a lighting adjustment.

10. The electronic control unit of claim 1, wherein the one or more vehicle signals comprise one or more advanced driver-assistance system (ADAS) signals, the one or more ADAS signals generated in response to ADAS detection of a vehicle operating condition operating outside of a threshold range.

11. A method for an electronic control unit for a vehicle comprising:
receiving, via one or both of a head unit and an amplifier, an audio input signal;
receiving, via an advanced driver-assistance (ADAS) system, one or more vehicle signals;
generating a notification in response to the one or more vehicle signals;
mixing the notification and the audio input signal to produce a mixed audio output signal;
transmitting the mixed audio output signal to the amplifier; and
playing, via a speaker, the mixed audio output signal,
wherein the electronic control unit comprises a first functional safety level greater than or equal to a functional safety compliance threshold.

12. The method of claim 11, further comprising:
monitoring the head unit, the amplifier, and audio network status;
confirming transmission of both of the audio input signal and the mixed audio output signal;
in response to an indication of transmission fault, generating a fault message; and, executing fault mitigation.

13. The method of claim 12, wherein the fault mitigation comprises one or more of displaying the notification via an advanced driver assistance system (ADAS) meter, playing the notification via an ADAS speaker, and generating the notification via an infotainment system.

14. The method of claim 11, wherein one or both of the amplifier and the speaker comprise a second functional safety level less than the functional safety compliance threshold.

15. The method of claim 11, further comprising;
transmitting, via an audio output channel, the mixed audio output signal to one or more of a tracking power supplier, a boosted integrated converter and a non-boosted integrated converter; and
transmitting, via an audio network interface, the mixed audio output signal to the head unit communicatively coupled to the amplifier.

16. The method of claim 11, wherein the notification comprises one or more of an audio signal, feedback vibration and lighting adjustment.

17. A system for a vehicle, comprising:
a head unit;
an amplifier;
a speaker;
an advanced driver-assistance system (ADAS); and
an electronic control unit communicably coupled to the head unit, the amplifier, the speaker, and the ADAS, the electronic control unit comprising:
an audio network interface configured to receive an audio input signal from the head unit via the amplifier;
a vehicle network interface configured to receive one or more vehicle signals from the ADAS;
a non-transitory memory storing instructions; and
a processor communicably coupled to the audio network interface, the vehicle network interface, and the non-transitory memory, the processor, when executing the instructions, configured to:
receive the audio input signal;
receive the one or more vehicle signals;
generate a notification in response to the one or more vehicle signals;
mix the notification and the audio input signal to produce a mixed audio output signal;
transmit the mixed audio output signal to the amplifier; and
play, via the speaker, the mixed audio output signal,
wherein the electronic control unit comprises a first functional safety level greater than or equal to a functional safety compliance threshold, and wherein the audio network interface, the vehicle network interface, the non-transitory memory, and the processor comprise the first functional safety level.

18. The system of claim 17, wherein one or both of the amplifier and the speaker comprise a second functional safety level less than the functional safety compliance threshold.

19. The system of claim 17, the processor further configured to:
transmit, via an audio output channel, the mixed audio output signal to one or more of a tracking power supplier, a boosted integrated converter and a non-boosted integrated converter; and,
transmit, via the audio network interface, the mixed audio output signal to the head unit.

20. The system of claim 17, wherein the processor, when executing the instructions, further configured to execute one or more of power on reset, brown out reset, cyclical redundancy check, windowed watchdog timer, hardware module self-test, software module self-test, and run time status check.
